(19) United States
(12) Patent Application Publication
(10) Pub. No.: US 2012/0147619 A1
(43) Pub. Date: Jun. 14, 2012

(54) AUXILIARY LIGHTING DEVICE FOR VEHICLE LAMP

(75) Inventor: MING-HSIEN TSAI, TAINAN (TW)

(73) Assignee: JUN YAN AUTO INDUSTRIAL CO., LTD., TAINAN (TW)

(21) Appl. No.: 12/965,115

(22) Filed: Dec. 10, 2010

(51) Int. Cl. F21V 5/00

(52) U.S. Cl. 362/520

(57) ABSTRACT

An auxiliary lighting device for vehicle lamps which is a refractive body is revealed. One end of the refractive body is a light emitting surface and the other end is a tapered curved surface. Moreover, curved light-gathering ridge lines and an emitter receiving slot for mounting light emitting diode (LED) are disposed on one end of the refractive body having the curved surface. Thereby linear light emitted from the LED is refracted by the emitter receiving slot into a plurality of radial lines. Then the radial lines are gathered by the curved surface to be emitted from the light emitting surface. The light refracted to the surface of the refractive body is guided by the light-gathering ridge lines to project toward the end of the refractive body with the light emitting surface. Therefore, intensity of the light from vehicles lamps is increased significantly to provide excellent illumination and warning signals.

### BACKGROUND OF THE INVENTION

1. Field of the Invention

The present invention relates to an auxiliary lighting device for vehicle lamps, especially to an auxiliary lighting device for vehicle lamps that increases light brightness of light emitting diode so as to provide excellent illumination and warning effect.

2. Description of Related Art

While driving at night, cars or motorcycles need vehicle lamps for lighting up the road in front of the vehicles. The vehicle lamps not only provide illumination for the driver to operate the vehicles, but also give warning signals to people or vehicles on lines in opposite direction and showing vehicle location and intention to turn. Thus vehicle lamp is one of essential components of the vehicles.

Refer to a Taiwanese Patent Pub. No. M259727 “auxiliary lighting device for vehicle lamp”, an auxiliary lighting device for vehicle lamps is revealed. The device has been used broadly. A light emitting diode (LED) is set on a lamp holder and then the lamp holder is assembled with a decorative ring formed by a plurality of oblique cut surfaces. The oblique cut surfaces are arranged to form a reflective surface. And a receiving slot is arranged at the rear side of the decorative ring so as to mount the LED. By such design, it is expected that light emitted from LED covers the whole decorative ring when LED is on. Moreover, the light from LED is reflected by the reflective surface so as to form a light ring with higher brightness. Thereby the light intensity of the vehicle lamp is improved to provide illumination and warning effect desired.

However, in practice, the device doesn't provide expected effects. This is due to focused lighting pattern of the LED and light emitted from LED is linear. Thus the light from LED is difficult to cover the whole decorative ring for being reflected by the reflective surface and generating light ring with high brightness. Thus the illumination and warning effect provided is limited.

In order to solve the above problems, there is a need to provide an auxiliary lighting device for vehicle lamp with improved design.

### SUMMARY OF THE INVENTION

Therefore it is a primary object of the present invention to provide an auxiliary lighting device for vehicle lamps that improves intensity of the light emitted from light emitting diode in the vehicle lamp effectively so that the vehicle lamp provides better illumination and warning effect.

In order to achieve the above object, the auxiliary lighting device for vehicle lamps of the present invention includes a refractive body with a flat light emitting surface on one end and a tapered curved surface on the other end thereof. Moreover, the surface of the refractive body on the sides opposite to the light emitting surface is arranged with curved light-gathering ridge lines. And an emitter receiving slot is concavely disposed on one end of the refractive body having the curved surface.

Thereby linear light emitted from the light emitting diode is refracted by the emitter receiving slot to form a plurality of radial lines. Then the radial lines are gathered by the curved surface on the opposite side of the light emitting surface. As to the light refracted to the surface of the refractive body, it is guided by the light-gathering ridge lines so as to be emitted toward the end of the refractive body with the light emitting surface. Thus the intensity of the light emitted from the light emitting diode in the vehicle lamp is increased dramatically so as to achieve excellent illumination and warning effect.

In addition, a plurality of flat surfaces formed by vertical cut is set around the refractive body. Thus the light refracted to the side of the refractive body is guided by the flat surfaces so as to be emitted from the light emitting surface. And the light is further gathered to improve the intensity of the light from the light emitting diode.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment according to the present invention;

FIG. 2 is a cross sectional view of an embodiment according to the present invention;

FIG. 3 is a schematic drawing showing assembly of an embodiment according to the present invention;

FIG. 4 is a schematic drawing showing an embodiment in use according to the present invention;

FIG. 5 is a perspective view of another embodiment according to the present invention;

FIG. 6 is a schematic drawing showing the embodiment in FIG. 5 in use according to the present invention.

### DETAILED DESCRIPTION OF THE PREFERRED EMBODIMENT

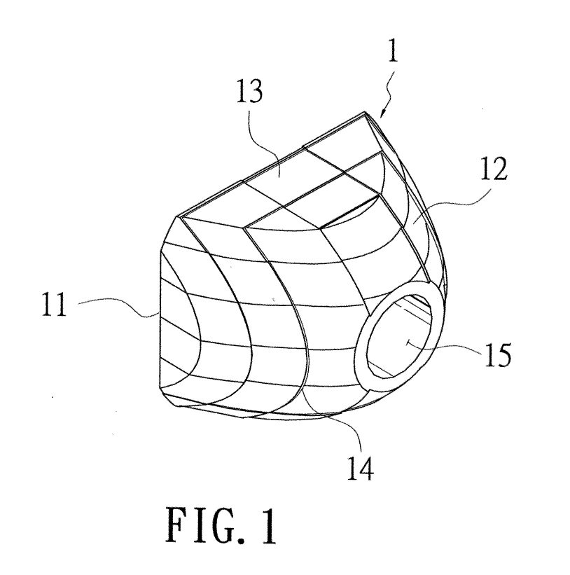

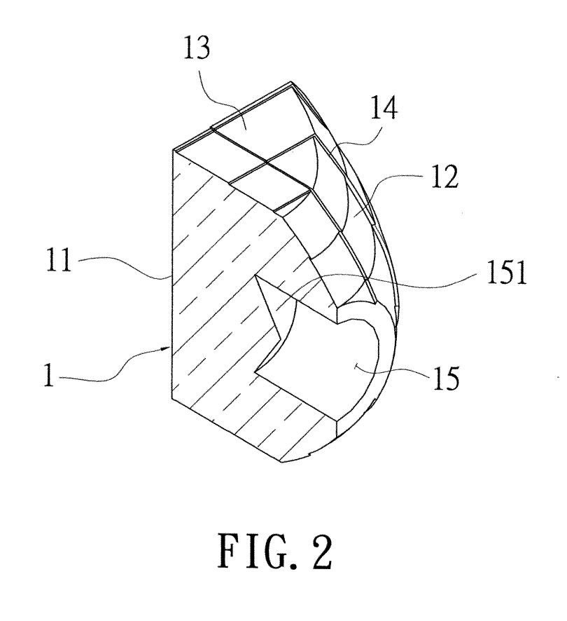

Refer to FIG. 1 and FIG. 2, an auxiliary lighting device for vehicle lamps of the present invention includes a refractive body 1. One end of the refractive body 1 is a flat light emitting surface 11. The refractive body 1 is tapered from the light emitting surface 11 to the other end thereof so as to form a curved surface 12. Moreover, a plurality of flat surfaces 13 formed by vertical cut is arranged around the refractive body 1. In this embodiment, there are four flat surfaces 13 distributed around the refractive body 1. Furthermore, a plurality of gradient curved light-gathering ridge lines 14 is arranged around the flat surfaces 13, on the surface of the refractive body 1 opposite to the light emitting surface 11. And an emitter receiving slot 15 is concavely disposed on one end of the refractive body 1 with the curved surface 12 and an awl-shaped part 151 is convexly arranged at the bottom of the emitter receiving slot 15. The awl-shaped part 151 that is a cavity communicates with an opening of the emitter receiving slot 15.

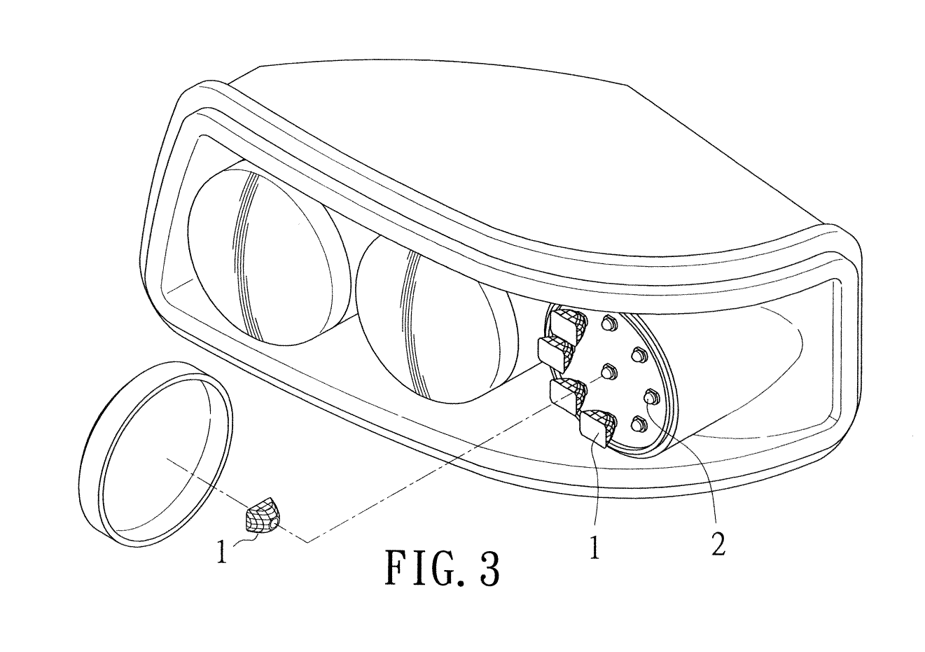

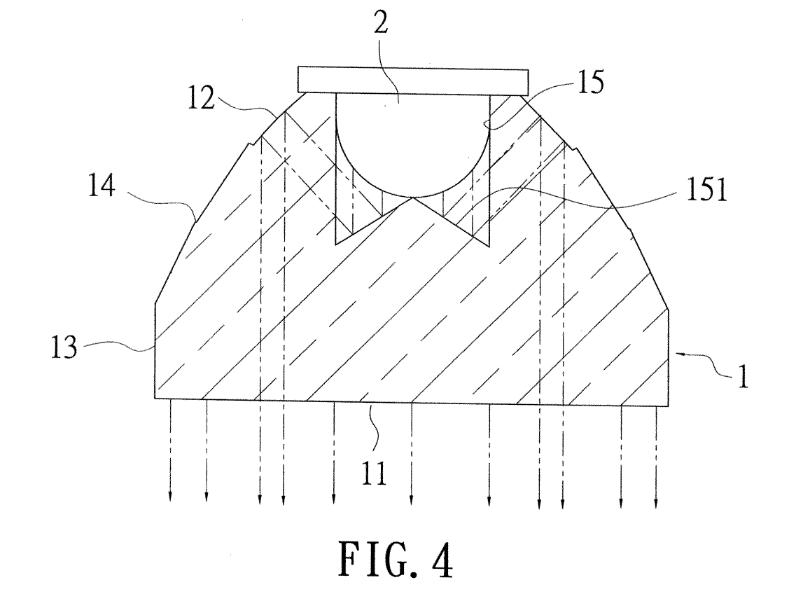

Refer to FIG. 3, while in use, the present invention is assembled with a third brake light or light emitting diode 2 of turn signal lights of cars. The light emitting diode 2 is mounted in the emitter receiving slot 15 of the refractive body 1 correspondingly. Refer to FIG. 4, thus light from the light emitting diode 2 emits into the emitter receiving slot 15 in parallel and then refracted by the awl-shaped part 151 of the emitter receiving slot 15 to form radial lines, scattered around the refractive body 1 when drivers intend to warning people or vehicles on lines in opposite direction, showing vehicle location or making turns.

Next the scattered light around the refractive body 1 is guided by the curved surface 12 (opposite to the light emitting surface 11) of the refractive body 1, gathered and emitted from the light emitting surface 11. Moreover, the light refracted to the surface of the refractive body 1 is guided and refracted by the light-gathering ridge lines 14 so as to be emitted toward the end of the refractive body 1 with the light emitting surface 11. Furthermore, the light projected to the side of the refractive body 1 is guided by the flat surfaces 13 formed on sides of the refractive body 1, along the flat surface 13 to be emitted from the light emitting surface 11.

The present invention uses the awl-shaped part 151 on the bottom of the emitter receiving slot 15 to refract the linear light from the light emitting diode 2 into a plurality of radial lines, scattered around the refractive body 1. Then the radiated and scattered light rays from the light emitting diode 2 in the emitter receiving slot 15 are guided and gathered effectively by the light-gathering ridge lines 14 on the surface of the refractive body 1 and the flat surfaces 13 on sides of the refractive body 1 to be emitted from the light emitting surface 11. Thereby the light intensity of the light from the light emitting diode 2 of the car lamp is increased significantly. People or vehicles on lines in opposite direction in the far distance can learn the location and the movement such as turning of the car driven by the user clearly. Therefore, excellent illumination and warning signals are provided.

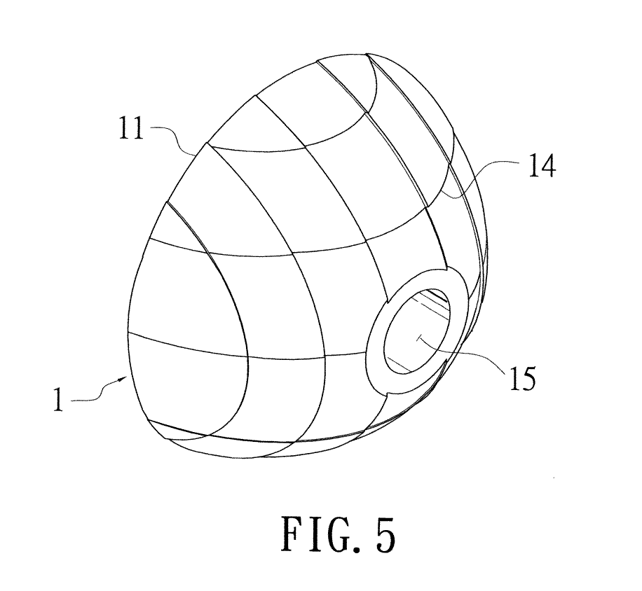

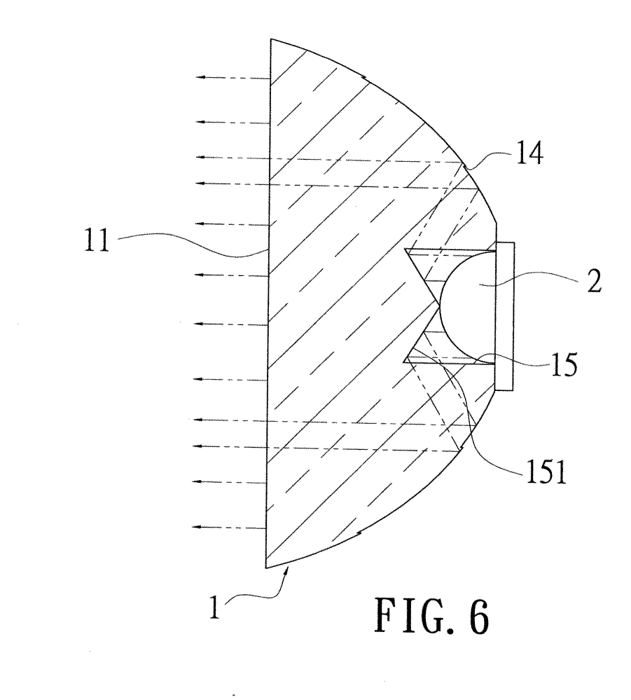

In addition, refer to FIG. 5 and FIG. 6, another embodiment of the present invention is revealed. The refractive body 1 is a hemisphere with streamlined curved surface therearound. This is another design of the refractive body 1 that gathers light and increases the intensity of light from the light emitting diode 2.

In summary, according to the above embodiments, the present invention has following advantages:

1. An awl-shaped part is formed on the bottom of the emitter receiving slot to refract linear light from the light emitting diode into a plurality of radial lines. Then by the refraction structure of the refractive body, the radial lines are gathered to be emitted from the light emitting surface of the refractive body. Thus the light intensity of the light emitted from the light emitting diode is significantly improved.

2. The refractive body is disposed with the curved surface, on the side opposite to the light emitting surface so as to guide and gather the light emitted from the light emitting diode and scattered around the refractive body. Thus the light is gathered effectively to be emitted from the light emitting surface of the refractive body. Therefore, the intensity of the light emitted from the light emitting diode is increased.

3. The light refracted to the surface of the refractive body is guided by the light-gathering ridge lines on the surface of the refractive body so as to be emitted toward the end of the refractive body with the light emitting surface. Thus the intensity of light emitted from the light emitting diode is further improved.

4. The present invention includes a plurality of flat surfaces formed by vertical cut arranged around the refractive body so as to guide the light projected to the side of the refractive body, moving along the flat surface to be emitted from the light emitting surface. Thus the light is further gathered so as to improve the intensity of light from the light emitting diode.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An auxiliary lighting device for vehicle lamps comprising
a refractive body;
a flat light emitting surface formed on one end of the refractive body;
a curved surface formed by the refractive body tapered from the end with the light emitting surface to the other end thereof;
a plurality of curved light-gathering ridge lines arranged at a surface of the refractive body, opposite to the light emitting surface of the refractive body; and
an emitter receiving slot disposed on one end of the refractive body having the curved surface.

2. The device as claimed in claim 1, wherein a plurality of flat surfaces formed by vertical cut is arranged around the refractive body.

3. The device as claimed in claim 2, wherein an awl-shaped part is convexly arranged at bottom of the emitter receiving slot and is communicating with the emitter receiving slot.

4. The device as claimed in claim 1, wherein the refractive body is a hemisphere with streamlined curved surface therearound.

5. The device as claimed in claim 4, wherein an awl-shaped part is convexly arranged at bottom of the emitter receiving slot and is communicating with the emitter receiving slot.

6. The device as claimed in claim 1, wherein an awl-shaped part is convexly arranged at bottom of the emitter receiving slot and is communicating with the emitter receiving slot.
